(19) United States
(12) Patent Application Publication
(10) Pub. No.: US 2017/0139409 A1
(43) Pub. Date: May 18, 2017

(54) AUTONOMOUS MULTI-ROTOR AERIAL VEHICLE WITH LANDING AND CHARGING SYSTEM

(71) Applicant: Robert CLARKE, San Francisco, CA (US)

(72) Inventor: Robert CLARKE, San Francisco, CA (US)

(21) Appl. No.: 14/858,795

(22) Filed: Sep. 18, 2015

(51) Int. Cl. G05D 1/00; G08G 5/00; G08G 5/02; B64C 39/02; B64F 1/36

(52) U.S. Cl. CPC G05D 1/0011; B64C 39/024; B64F 1/362; G08G 5/02; G08G 5/0082; B64C 2201/027

(57) ABSTRACT

A remotely deployable network of multi-rotor aircraft and landing stations enable widespread use of multi-rotor aircraft in varied environments and application scenarios. A multi-rotor aircraft having modular components to facilitate a range of applications performs remote operations. Landing stations provide a power source to remote aircraft and facilitate semi-autonomous landing. A computing device facilitates use interaction with a network of multi-rotor aircraft and landing stations that together form a network for transmitting data concerning individual and regional aircraft operations.

### PRIORITY CLAIM

This application claims priority to U.S. Patent Application No. 62/052,018, filed Sep. 18, 2014 and titled, “AUTONOMOUS MULTI-ROTOR AERIAL VEHICLE WITH LANDING AND CHARGING SYSTEM,” the contents of which is incorporated by reference in its entirety.

### FIELD

The present invention relates to a system and method of remotely deployable modular drones, drone charging stations, and related software that enable widespread use of drone operations without the cost and complexity of purchasing and maintaining a drone.

### BACKGROUND

Flying robots, commonly referred to as drones, are a form of autonomous air vehicle capable of performing a range of tasks with minimal human interaction. One of the more popular forms of drone amongst amateurs and a growing crowd of professionals is the multi-rotor aircraft, which is capable of vertical takeoff and landing, enabling them to be deployed and operated virtually anywhere. These systems have found widespread adoption due to their simplicity, versatility and ease of use.

Flying autonomous vehicles, including drones, first came to widespread use in the military arena, performing long duration surveillance missions. Technological progress allowed the cost of the enabling technologies to fall to the point where hobbyists are now capable of fielding a range of unmanned aerial vehicle systems through the use of low cost, off-the-shelf sensors, and computer hardware.

The advance of robotics and the ever-decreasing cost of computational hardware have lead to an increased use of autonomous vehicles for tasks ranging from the hazardous to the tedious and mundane.

While drone systems first found adoption in hobbyist communities, they are currently being fielded for a range of applications due to their low cost and simplicity. As adoption of drone technologies becomes more widespread, uses for this technology will emerge in the fields of action sports, aerial photography, journalism, oil and gas exploration, construction, surveillance, agriculture, and many more.

However, current drone systems have several barriers to entry, preventing them from widespread adoption. For example, existing systems tend to be highly complicated, requiring new users to spend considerable sums to purchase flight systems and the associated equipment necessary for flying a drone. In addition to the financial investment, an extensive amount of time is spent in flight training, learning the basics of radio control aircraft flight, landing, maneuvering, and collision avoidance. Even after a user has made the significant financial and time investments associated with existing drone systems, they are then confronted with additional technical limitations placed on them by existing battery technology. Existing battery packs offer limited flight times and require the operator to be present to swap batteries once they have discharged, which means the operator must further invest in spare battery packs and transport them every time they wish to operate a drone.

Further, local and state governments, and the Federal Aviation Administration, have only recently begun to consider how to regulate drone usage, consistent with existing privacy and noise abatement laws, and how to integrate drones into the national airspace. The government has the power to radically alter the industry through regulations that have yet to be determined.

Because of the limited capacity of the battery packs used today in multi-copters there is a need for a high level of human involvement in the maintenance of drone systems, particularly in swapping depleted batteries.

Accordingly, what is needed is a remotely deployable drone system that is accessible via a communication link to users anywhere in the world. What is further needed is a remotely deployable drone system that can be adopted by users without costly training and expense, and provides a means of minimizing human involvement by providing a charging platform that can be remotely located allowing the drones to be located anywhere. What is further needed is a drone system that can adapt to governmental oversight of the drone industry and remove some of the risk for individual users.

### BRIEF DESCRIPTION OF THE DRAWINGS

A better understanding of the present invention can be obtained when the following detailed description of the preferred embodiment is considered in conjunction with the following drawings, in which:

FIG. 1 contains a high-level block overview of an exemplary drone system according to embodiments of the invention;

FIG. 2 contains a drawing of an exemplary drone device according to embodiments of the invention;

FIG. 3 contains a block diagram of an exemplary drone system according to embodiments of the invention;

FIG. 4 contains a block diagram of a communication network in accordance with embodiments of the invention;

FIG. 5 contains a diagram of an arm unit in accordance with embodiments of the invention;

FIG. 6 contains a diagram of landing gear assembly in accordance with embodiments of the invention;

FIG. 7 contains an overview of the components of an exemplary base/charging station in accordance with embodiments of the invention;

FIG. 8 contains a flowchart of an exemplary positioning and landing sequence.

FIG. 9 contains a diagram of an exemplary infrared receiver in accordance with embodiments of the invention;

FIGS. 10a-10c contain a flowchart illustrating a method for landing, docking, and maintaining a drone in accordance with embodiments of the invention; and

FIG. 11 contains a flowchart of an exemplary mission operation in accordance with embodiments of the invention.

### SUMMARY

In some embodiments, a remotely deployable modular drone system may include a multi-rotor aircraft configured for vertical takeoff and landing and/or one or more remotely locatable landing pods, each configured to pair with, and provide an electrical charge to the multi-rotor aircraft. In some embodiments, the multi-rotor aircraft and the landing pods form a network for relaying data to other multi-rotor aircraft and other landing pods. In some embodiments, the multi-rotor aircraft is further configured to coordinate with one of the landing pods to land thereon substantially autonomously. In some embodiments, such a system may further include a computing system configured to receive user instruction data and transmit the data to the network. In some embodiments, the landing pods may further include an electromechanical interface to establish an electromechanical connection with the multi-rotor aircraft. In some embodiments, the multi-rotor aircraft receive sensor data collected by the one or more landing pods to facilitate landing. In some embodiments, the sensor sensor data is collected by a pressure sensor. In some embodiments, the sensor sensor data is collected by an infrared proximity sensor. In some embodiments, the one or more landing pods may further include an electromechanical interface configured to mate with the multi-rotor aircraft and a locking mechanism for securing the multi-rotor aircraft to the landing pod. In some embodiments, the the communications system is further configured to communicate with a remote computing device. In some embodiments, the landing pods are configured to operate as part of a ground-based sense-and-avoid system that monitors traffic within a local airspace.

In some embodiments, a remotely locatable landing pod may include a landing platform configured to receive and support a multi-rotor aircraft, an electromechanical interface to establish a mechanical connection with the multi-rotor aircraft, a power supply for providing an electrical charge to a multi-rotor aircraft, one or more sensors for detecting the presence of a multi-rotor aircraft, a communications subsystem, and/or a landing subsystem for analyzing data received by the sensor and communicating with the multi-rotor aircraft to facilitate receipt of the multi-rotor aircraft by the landing platform.

In some embodiments, the communications subsystem may include one or more transceivers for communicating with a multi-rotor aircraft and with other landing pods. In some embodiments, the electromechanical interface may further include a power conduit configured to mate with the multi-rotor aircraft and a locking mechanism for securing the multi-rotor aircraft. In some embodiments, the communications system is further configured to communicate with a remote computing device. In some embodiments, the communications subsystem is further configured to communicate with a remote computing device and receive instruction from a user on operation of the multi-rotor aircraft. In some embodiments, the sensor is a pressure sensor. In some embodiments, the sensor is an infrared proximity sensor.

In some embodiments, a communications network may include a group of nodes. In some embodiments, the group of nodes may include landing pods, multi-rotor aircraft node, and computing devices. In some embodiments, the landing pod nodes and the multi-rotor aircraft may include a group of sensors that generate data concerning the location and status of the nodes. In some embodiments, the nodes are configured to receive, transmit, and relay data from other nodes in the network. In some embodiments, the computing device is configured to provide instruction to at least one multi-rotor aircraft via the network. In some embodiments, the sensor is an infrared proximity sensor. In some embodiments, the communications subsystem is further configured to exchange data with other landing pods in a network.

### DETAILED DESCRIPTION

A modular autonomous aerial vehicle and support system is disclosed. In exemplary embodiments, the system of the present invention comprises a multi-rotor drone that is in communication with one or more remotely locatable landing pods that may be used to charge the vehicle and relay data from the vehicle to other nodes on a network. In embodiments, the vehicle may be programmable and configurable to carry out user-specified functions, and may autonomously land on a base station using a combination of sensors. A user interface may be provided for remotely commanding the drone.

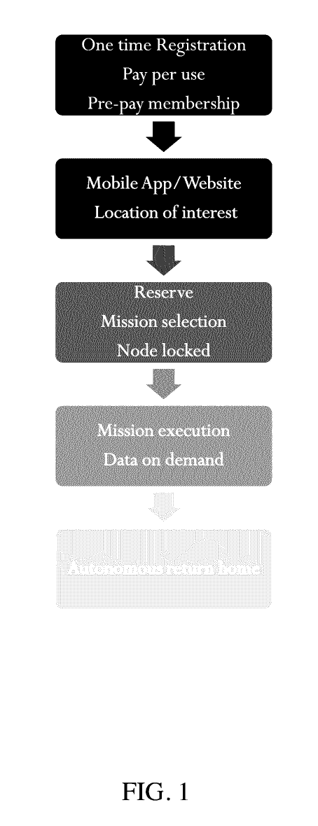

In a preferred embodiment, the drone may receive high level operator commands via a relay from the base station and perform those functions autonomously with minimal input from the operator. In embodiments, the drone may provide navigational feedback, telemetric feedback, and operator-selected data and transmit this information to the closest base station within range to facilitate command and control of the drone. A high-level overview of an exemplary drone system is shown in FIG. 1 in which an exemplary drone mission is shown.

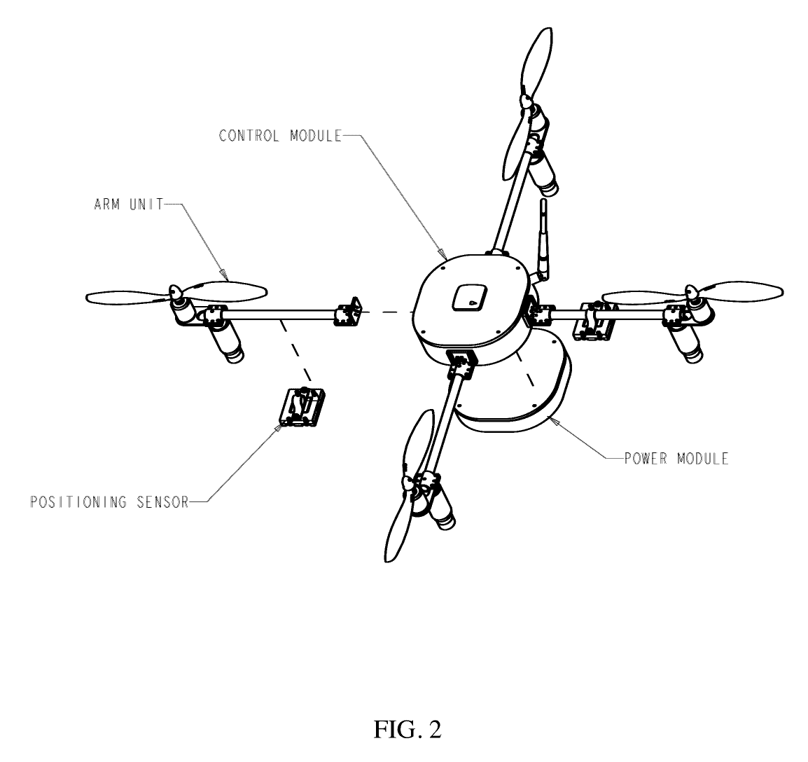

Referring to FIG. 2, an exemplary drone device is shown. In embodiments, a drone system may comprise of several modular units, which together may act as a complete flight system. At the basic level a drone may be comprised of a control module (computer-controlled autopilot and sensors which through software control the real time flight behavior of the system), arm modules (comprised of motors, propellers, landing gear and the interface lock to provide the thrust needed for flight), and a power module (comprised of a battery pack, power distribution, sensors and speed controllers to power the entire flight system). To complement the flight system and make for a fully deployable solution, each drone may be paired with a base station that acts as a charging base, landing platform, data communication hub, and control station.

It will be appreciated that the system of the present invention is designed with flexibility in mind and that the drone can take on a quad-, hexa-, or octo-copter configuration, but is not limited to any particular configurations and may expand as design requirements evolve over time.

In embodiments, the drone may comprise one or more core modules that can provide various capabilities to the drone, including telemetry, imaging, communication, or other features. These modules may be permanently integrated into the drone or may be swappable. In embodiments, functionality may be added or removed through hardware or software updates.

In embodiments, each module may be connected through a proprietary electromechanical interface, which operates as both the physical structural connection between each module and the electrical/logical interface. In embodiments, the interface may comprise a “slide and lock” mechanism that allows for easy and simple assembly. With such a configuration, once a module is placed in its operating position, electrical contact is made between the units to allow for the necessary power and control signals to be sent between the modules.

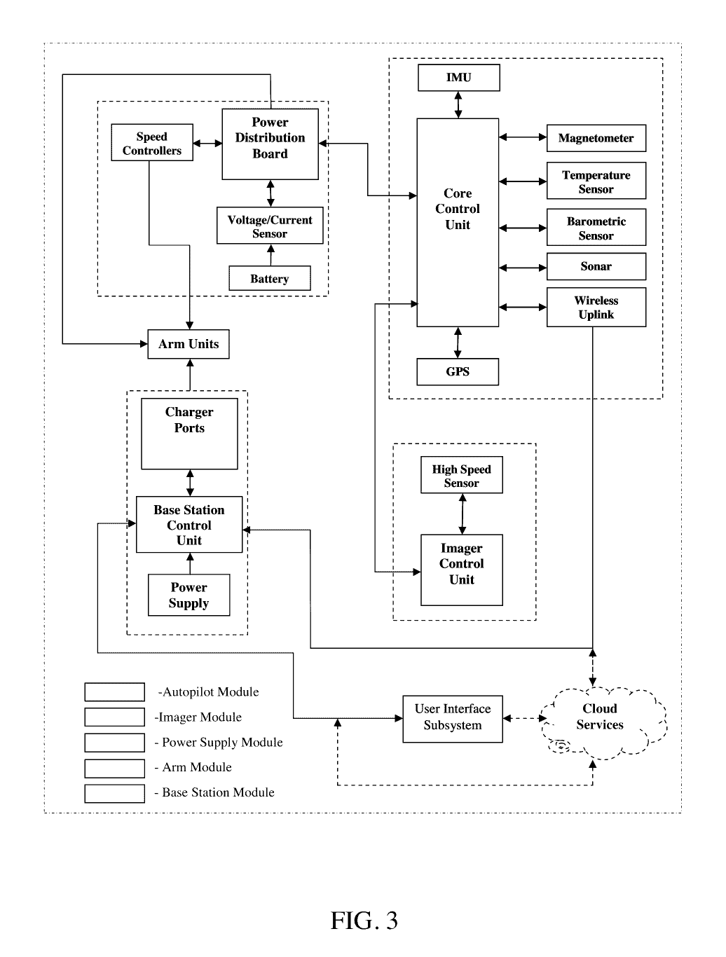

In an exemplary embodiment, the interconnected modules may include an imaging module, autopilot module, propulsion module, power supply module, base station module, and user interface. FIG. 3 is a system diagram showing the modules in an exemplary embodiment.

In embodiments, the modules may interface with—or be under the control of—a core control unit “CCU.” In a preferred embodiment, the CCU is a microprocessor with image and graphics processing capability, and the ability to interface with peripherals and sensors over conventional data links. One such example is the AM3358 ARM Cortex CPU by Texas Instruments, though any number of devices could be substituted.

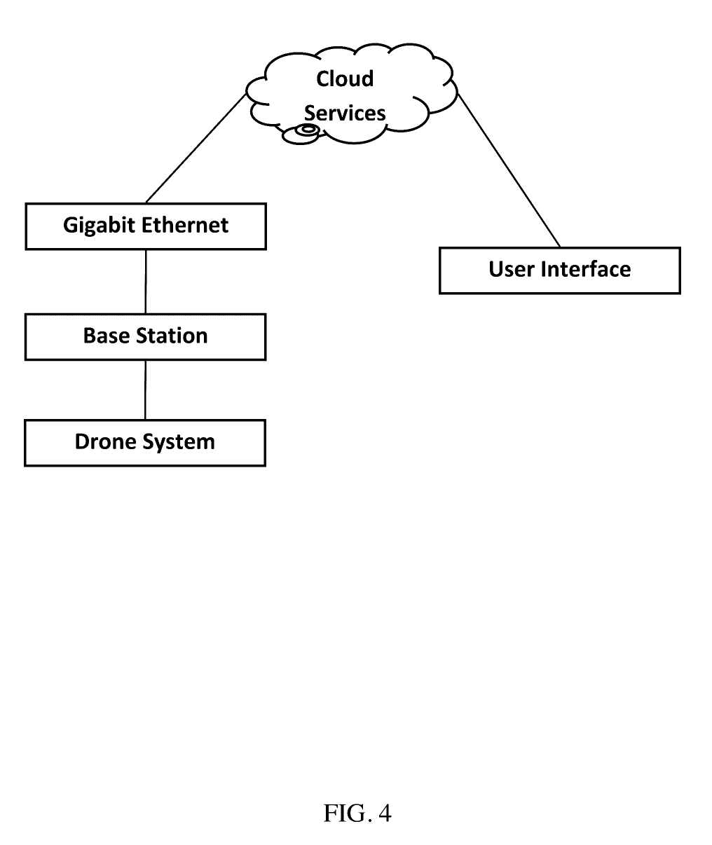

In embodiments, CCU controls and directs the operation of the various modules, including controlling the autopilot module, controlling the speed controllers in the power subsystem, coordinating data transfer to the interface subsystem, acting as a means for system diagnostics and upgrade. In exemplary embodiments, CCU will include interfaces for communicating over a gigabit Ethernet link, and for communicating with the autopilot and wireless uplink modules. FIG. 4 contains an overview of a communication system in embodiments of the invention, showing the link between the user and the drone system.

In embodiments, software and/or firmware may be preloaded into the CCU to control various aspects of the drone system. Software/firmware may also act a dynamic control of the system and be used to configure, tune and operate all sensors onboard. In embodiments, software/firmware may be dynamically updated, either wirelessly, through a link with a base station, via a physical connection, or otherwise. In embodiments, software/firmware may also monitor the telemetry data being received by the individual sensors, process that data, and provide the necessary feedback signals to the flight system to maintain optimal operations.

In embodiments, software/firmware may consist of a multilayered architecture comprising a hardware access layer and a logic layer.

In embodiments, a hardware access layer may be comprised of the sensory inputs from the sensors (refer to system diagram) to the microcontroller, the analog to digital conversion, and any universal asynchronous receiver/transmitter, or related sensors.

Similarly, a logic layer may comprise the necessary logical elements needed to ensure the safe functioning of the drone. One example of these logical elements is a Kalman filter which is used to provide accurate real time information on the movement of the aircraft by combining the data from onboard accelerometers, gyroscopes, magnetometers, etc., and computing linear solutions based on the non-linear input from the sensors. Alternatively, a proportional-integral-derivative controller may be used in a logic layer as a feedback mechanism for accurate control of the drone system.

In embodiments, the system of the present invention may include an imaging module for capturing high definition video or still images, and transmitting those images over a data link or recording the data to a storage medium.

A high speed sensor may be provided to capture high resolution imaging data and transmit that data over a high speed sensor interface in the imaging module. In embodiments, the imaging module may communicate with the CCU to allow a user control to have control over the imaging module.

In embodiments, the imaging module may be detachable from the main body of the system to allow for field replacements or upgrades. In further embodiments, high speed sensor may have the capability to record video and still images across the entire electromagnetic including, for example, infrared and X-ray wavelengths.

In a preferred embodiment, the imaging module may have the following minimum characteristics:

| Parameter | Value |
|---|---|
| Resolution | 14 Mp |
| HD Recording | 1080p/1080i |
| Frame Rate | 30 Fps/60 Fps |
| Data rate | Image Mode—up to 960 Mbps |
| | Control Mode —12 Mbps downlink and 48 Mbps |
| | uplink |
| Data Transfer | Image Mode—12 bit |
| Format | Control Mode—8 bit |
| Voltage | Exact value TBD range 3.7-14.8 V ± 5% @ TBD |
| | mA |
| IR Recording | 640 X 480 long wave |
| SNR | >= 45 dB |

An autopilot module may be provided for controlling the flight movement of the drone system, and may be capable of controlling the position and flight characteristics of the system. In embodiments, autopilot module may gather and process data, including data from a plurality of sensors, to provide real-time telemetry information.

In embodiments, one or more autopilot module components provide the CCU with real time telemetry/positioning data to ensure accurate positioning and control of the system. In a preferred embodiment, autopilot module comprises sensors such as GPS, barometer, sonar, thermometer, magnometer, and inertial measurement for measuring the velocity, orientation, and the gravitational forces to which the drone is being subjected.

In a preferred embodiment, the autopilot module components may have the minimum following characteristics:

| Parameter | Value |
|---|---|
| GPS | Mediatek-3329 or better |
| Magnetometer | HMC5883L 3-axis Compass |
| IMU | InvenSense MPU 6000/6050 series or better |
| Sonar | MaxSonar EZ0 |
| Barometric Sensor | BMP085 by Bosch or better |
| Temperature Sensor | BMP085 by Bosch or better |
| Optical Flow Sensor | ADNS3080 Mouse sensor or better |
| IR Photodiode | Advanced Photonix PDB-C613-2 |

In a preferred embodiment, the autopilot module interface may have the following characteristics:

| Parameter | Value |
|---|---|
| Physical Media | CAN PHY |
| Data rate | Up to 1 Mbps |
| Data Transfer | 1 start + 8 bit + 1 parity + 1 stop |
| Format | |
| Cable type | TBD |
| Cable length | TBD |

The autopilot module may further include a wireless uplink interface for connecting to a base station and for receiving and transmitting data from a base station.

In embodiments, the autopilot module may be equipped with a wireless radio uplink to facilitate remote viewing and operation. This wireless uplink may be in the form of a 5.8 GHz radio or other standard wireless data protocols such as 4G data modem, and may vary according to the operating scenario. The wireless uplink may accomplish remote operation by the transmission of telemetry data acquired from the autopilot module back to the remote operator, and vice-versa. The uplink may also transmit image and video data acquired by the imaging module to the remote operator.

In a preferred embodiment, the uplink may have the following characteristics:

| Parameter | Value |
|---|---|
| Physical Media | TBD |
| Signals | Control Source, Voltage 12 V, HD |
| | Video/Images, Telemetry Data |
| Protocol | TBD |
| Measured TCP/IP | Up to 300 Mbps |
| Maximum Sustained | |
| Throughput | |
| Range | TBD 2 mile LOS minimum requirement |
| Frequency | 5.8 GHz (Preliminary) |
| Voltage | 12 V(Preliminary) |
| Power | 500 mW (Preliminary) |

In embodiments, an arm module may be provided to control the movement of the drone. Arm module may comprise motors, propellers, a landing gear, and the interface lock to provide the thrust needed for flight, among other components.

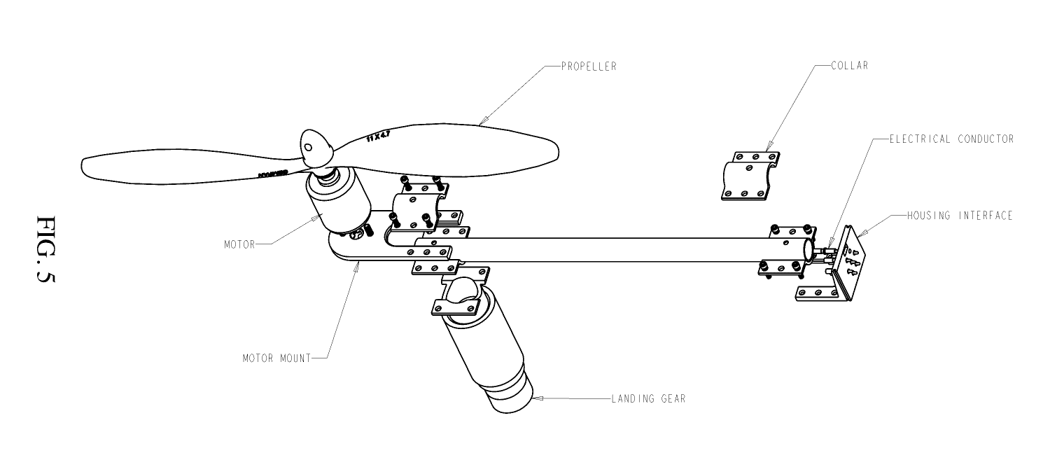

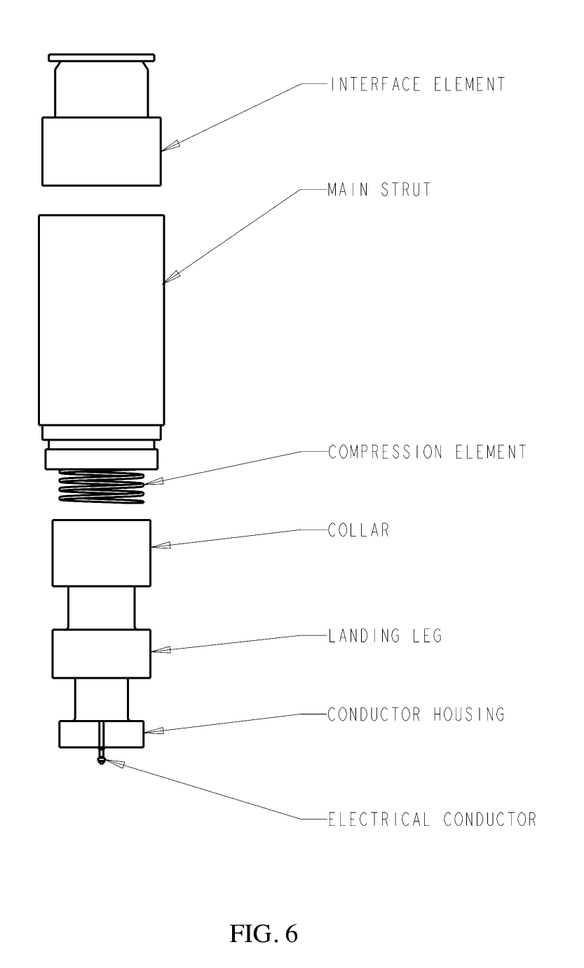

A diagram of an exemplary arm unit is shown in FIG. 5, and an exemplary landing gear assembly is shown in in FIG. 6.

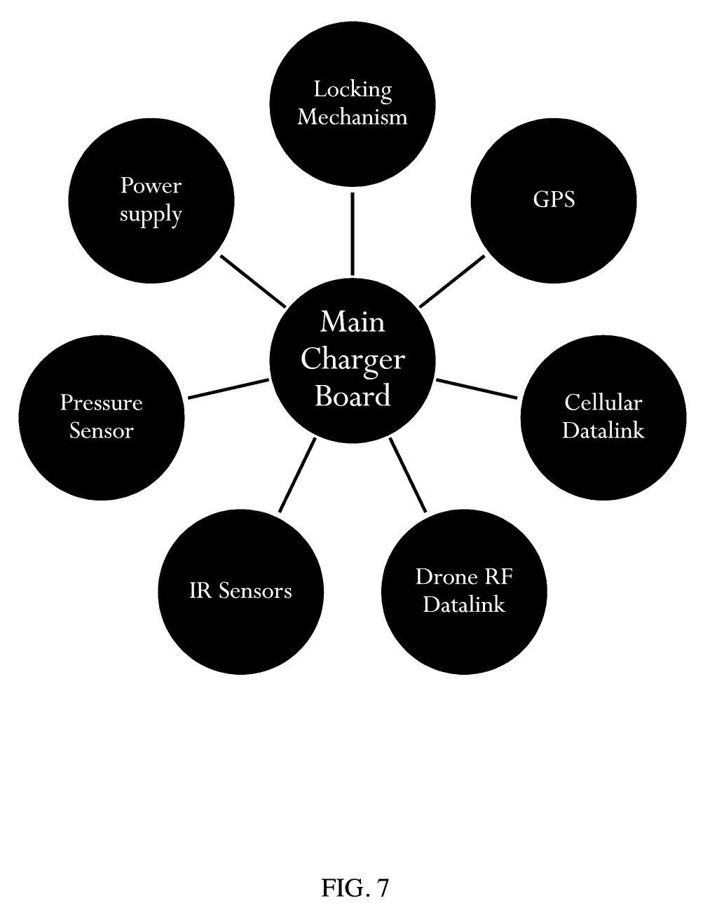

Arm positioning unit may be provided to establish a mechanical connection between the motors and the drone system through the use of an electromechanical interface described herein. In embodiments, the arm positioning unit can provide electrical connection between these two units, acting as both a mechanical and electrical point of contact. In a preferred embodiment, the arm unit has a minimum of seven electrical points contact points to facilitate electrical control of the motors by providing power, logical signals and electrical grounding. These contact points can also act as power transfer contacts to facilitate the charging of onboard battery packs when the drone system is docked with a base station and is charging. When not charging, these contact points may be used to perform other power monitoring tasks as necessary. FIG. 7 contains an overview of the components of an exemplary charging station.

In embodiments, the connector may also act as a charging port for the battery cells, and the configuration of the battery cells will determine the number of additional contact points.

In a preferred embodiment, a three-phase brushless DC motor is powered by a multi-cell lithium-ion polymer battery pack. In such a configuration, a multi-point charging pad may be used with three points of contact servicing the brushless DC motor, one contact point for ground, and a contact point for each cell in the pack. Myriad configurations are contemplated, from a single 3S battery to 4 3S or a single 12S batteries for heavy lift operations.

In a preferred embodiment, the arm module may have the following characteristics:

| Parameter | Value |
|---|---|
| Number of Contacts | 3 for Motor drive (other contact requirements |
| | TBD) |
| Actuators type | TBD |
| Power rail for motor | 5 V |
| Current | 2 A |
| Control Interface | Included in the Power Supply Module |

Arm module may also include a motion and positioning unit for providing the thrust necessary for flight operations as well as the necessary sensory units needed to perform accurate landing maneuvers when docking with the base station. In embodiments, thrust may be provided to the drone through the use of brushless DC motors, whose speeds are varied and controlled through signals sent from the autopilot module via the interface described herein. While gross positioning of the drone system may be performed by the autopilot module through the use of the GPS and the other onboard sensors comprising the autopilot, landing operations for approach and docking with a base station may need to be supplemented due to inherent inaccuracies of these sensors.

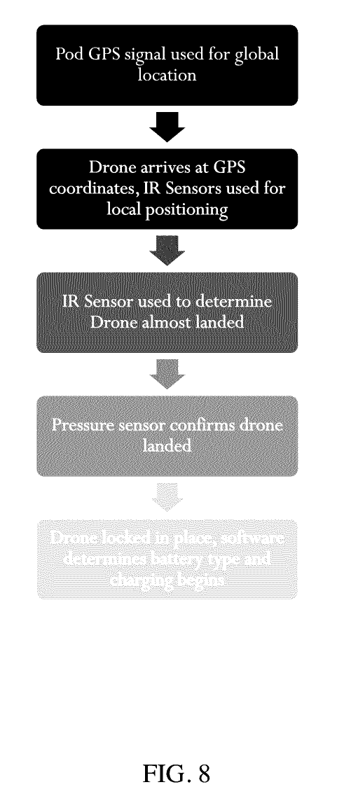

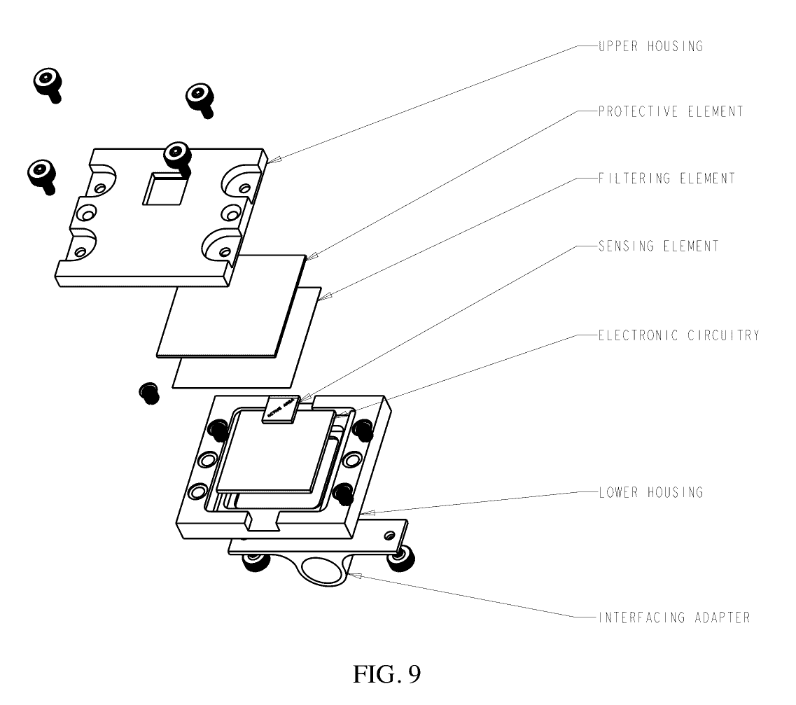

In embodiments, arm unit houses a series of sensors for enabling accurate positioning of drone systems to ensure accurate landing position every time it docks with a base station. In embodiments, off-the-shelf sensors may be used including, for example, passive infrared and acoustic sensors, which may be narrow-banded and paired with active sensors and signal generators on the base station and active onboard optical sensors with image recognition algorithms in place to detect optical targets on the base station. In a preferred embodiment, as a drone approaches the base station, a search algorithm is initiated to identify transmitting signals and optical targets to accurately position the drone each and every time for landing. A sample landing sequence is described in the flowchart of FIG. 8. An exemplary infrared receiver is shown in FIG. 9.

In embodiments, a base station may be provided for allowing drone systems to accurately and repeatedly dock and charge when needed, including sensors, networks and any other intelligence necessary to facilitate safe autonomous landing and docking operations.

In embodiments, base station may provide connectivity between drone and a user interface during regular flight operations, and may act as a hub for relaying data. A plurality of interconnected base stations may act as a conduit for communicating data.

In embodiments, a base station may act as a local positioning system for locating and positioning a drone as the drone approaches a base station for landing and docking. For safe and repeatable landing, drone may require accurate position data that may be beyond the capability of available GPS systems.

In embodiments, base station provides a means of allowing remotely located drone systems to be commanded through a user interface and relay navigational and operator-selected data. Where applicable, the base station may utilize local infrastructure (e.g., power supply, network or Internet connectivity, etc.) to meet the electrical and data requirements needed for performing its functions. Where local infrastructure is unavailable, self-contained systems may be provided to meet the electrical and data requirements.

A user interface may be integrated as software, a web-based application, a mobile application, dedicated terminal, or any means by which the user can provide direction to the drone system and receive feedback.

In embodiments, base station module may be integrated into a ground-based sense-and-avoid system that monitors drone traffic within the local airspace and hands off air traffic monitoring to any adjacent base station module system as a drone enters and/or leaves their coverage area. By monitoring telemetry information received from multiple drone systems and assigning specific flight corridors and airspace exclusion zones, safe and collision-free operation of all drone systems within a local airspace is assured. A network of such base stations may be deployed within a city to monitor and control all drone traffic within the coverage area. This is accomplished based on algorithms embedded within the CCU of the base station.

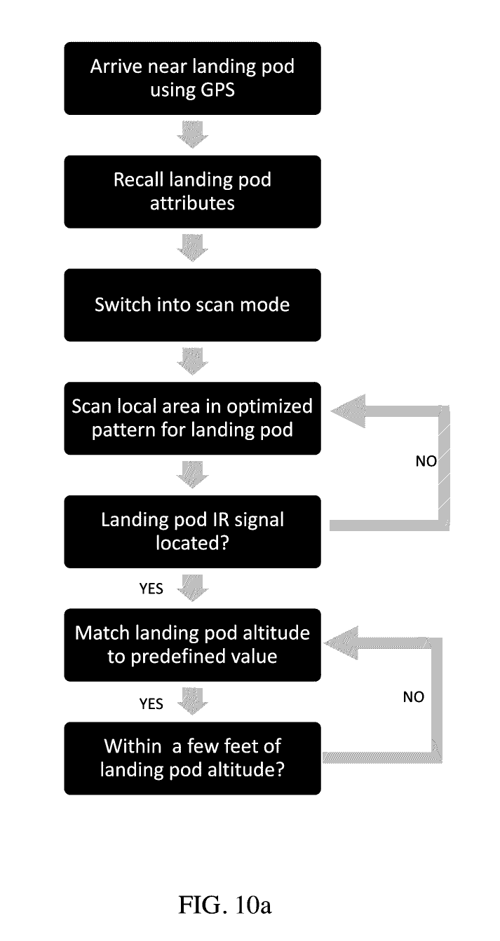

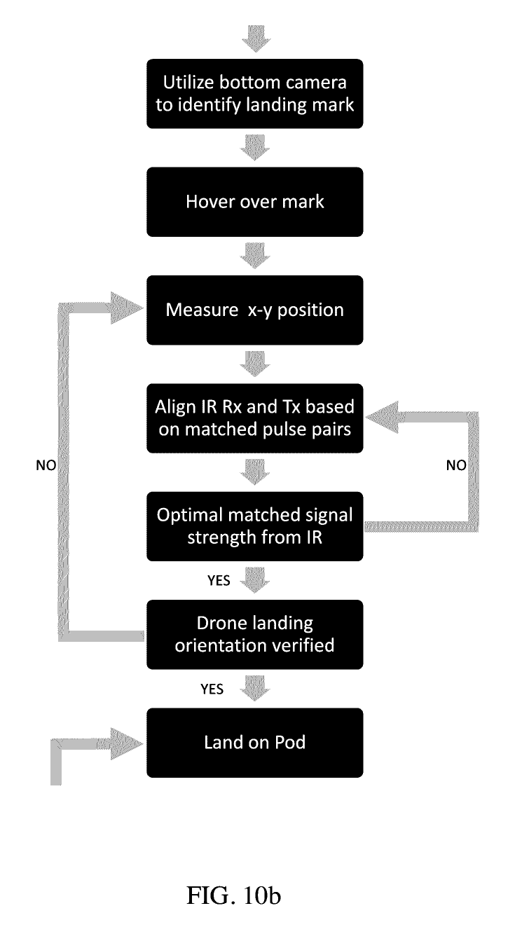

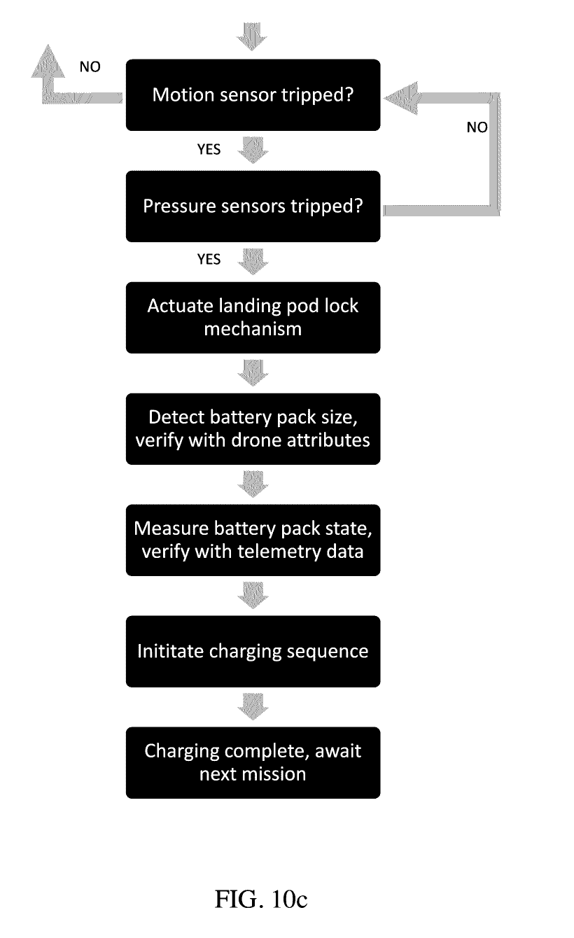

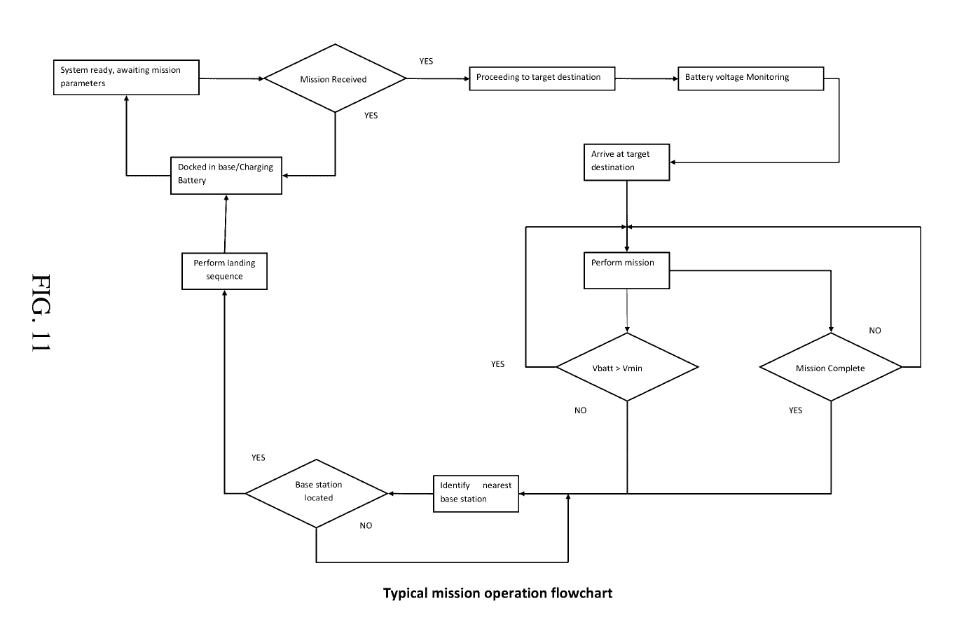

In embodiments, base station may provide a secondary locating and positioning methodology. FIGS. 10a-10c contain a flowchart showing an exemplary method for landing:

(1) GPS—Location data is used on each base station to provide global positioning data. Around each base station is a geo-fenced region of interest which incorporates the inherent errors in the GPS positioning data as well as a minimum operational safety buffer, this geofenced location may be used by a drone system to allow it to locate the nearest base station with an accuracy of a few meters.

(2) Signal Intensity and Time of Flight—Once a drone system has entered into a geofenced area of interest, the drone system enters into a predefined flight path to allow the drone to determine its position using trilateration by measuring the relative signal strengths of the drone system's RF and cellular antennae where applicable. In conjunction to trilateration techniques, positional information may also be obtained through the use of an in-phase/quadrature demodulation structure.

(3) Infrared—Once the location of the drone system has been updated with the information obtained through the two previous steps, another tighter predefined landing approach flight path is taken to align the system for landing and docking sequence. Multiple high power IR signal generators for emitting IR signals are used to provide finer positioning data for the drone which has a number of infrared receiving devices optimized to detect the emitted signals and realign itself for final landing.

(4) Indicating Markers—Each base station is fashioned with a series of identifying and locating markings to allow the downward facing camera on drone to identify these markers and calculate the optimal landing location. This positioning is further refined by the addition of an optical flow sensor on each drone system as described in the previous sections.

(5) Sonar/TOF—TOF measurements provide accurate estimates for determining the distance one object is from the other and ensure collisions are avoided.

(6) Passive IR Motion Sensor. Used to determine drone landing proximity to base station.

(7) FSR. Force-sensitive resistors are used on drone to verify drone touch down on base station. Each FSR sensor has a range of ˜0.2N-20N.

Not all of the above steps may necessarily be used, and additional positioning functionality is contemplated.

In embodiments, base station may provide system monitoring functions by relaying information about the drone from the drone to a central monitoring and maintenance center. In embodiments, this information may be provided to determine maintenance schedules for a particular drone, identify the need for software or hardware upgrades, or diagnose problems with the drone.

In embodiments, a gigabit Ethernet interface may provide connectivity from the base station to a network to facilitate remote control and operation of the system. In embodiments, the network may be a local area network (“LAN”).

In a preferred embodiment, the gigabit Ethernet interface may have the following characteristics:

| Parameter | Value |
|---|---|
| Technology | 1000BASE-T (IEEE 803.3ab) |
| Cable length | Up to 328 feet (100 m), per segment |
| Number of wires | Four pairs |
| Cable type | Cat-5, Cat-5e, Cat-6, or Cat-7 |
| Power over | Up to 15.4 W of DC power, minimum 44VDC @ |
| Ethernet | 350 mA |
| Measured TCP/IP | Up to 300 Mbps |
| Maximum | |
| Sustained | |
| Throughput | |

In the absence of a LAN, a wireless data connection may be substituted for the gigabit Ethernet interface

A user interface module may be provided for facilitating communication between the user the and drone and allowing the user to control the drone.

In an exemplary embodiment, a user interface module may direct image acquisition and viewing functions.

In embodiments, user interface module may allow the user to request additional drone functionality to be loaded onto the drone or perform additional data processing to be performed with data received from the drone.

For example, a user may be able to select different type of missions from an interface, choosing between a basic aerial photography mission, or a persistent surveillance task where multiple drones monitors a single area over time, small package delivery or remote sensing. Depending on the configuration, a user may utilize a hyperspectral imager to apply various filters to photos or videos and be able to identify different objects based on their electromagnetic signature. Such a feature could be used to determine what mineral types are within the field of view, evaporation rates, crop health, or even chemical or particulate detection in the atmosphere.

In embodiments, user interface system may communication with the drone over a data link that may include wireless and wired communication links, and may incorporate a network of interconnected base stations for receiving and relaying data.

In a preferred embodiment, a user may interface with the system either through a mobile application running on a smartphone/tablet or through a web-based interface. In embodiments, the launch page of the mobile application may prompt a user to specify whether they would like to view past activity or perform a new transaction. From there the user may specify the GPS location of interest and wait for a list of available drones within the network to be displayed. Once selected, the user may select the type of mission to be performed and whether to receive the data in real-time or distributed to them at a later date through the use of cloud-based services.

Countless functions and possibilities are available using the system of the present inventions.

### Case Example 1

A user in need of aerial footage lacks the technical resources to obtain an aerial view. The user is able to log on to the system of the present invention, using a web interface or mobile application, request drone flight time, specify the location of interest and the type of services they require. A drone within the network is selected, is locked to that user, performs the requested task (aerial video) and returns back to a charging platform when completed. Aerial photography can be used in a large number of industries, traffic monitoring, news reporting, real estate, construction monitoring, safety patrols, security patrols, agricultural crop monitoring, environmental protection, 3D mapping, emergency response, mining, logging etc. The data may then be made available to the user.

### Case Example 2

A drone owned and operated by another entity is being flown in the airspace but requires a persistent presence, something current battery technology prohibits, as such the batteries need to be periodically recharged. The foreign drone is permitted to use a charging station within the system of the present invention. The user again logs into the system, but rather than drone time, the user requests charging time. The system identifies the charger closest to the drone, based on its GPS coordinates and directs the drone to landing and charge. The user's account is charged and once completed, they are able to redeploy their drone at will.

### Case Example 3

Similarly, because all drone traffic needs to be monitored in the area, the user is obligated to opt-in a traffic control system. The ubiquity of the system of the present invention ensures this as another revenue stream.

### Case Example 4

As a supplement to existing delivery services, drones offer the ability to simplify and streamline operations. The main delivery truck can be parked within a neighborhood, and the drone acts to ferry the packages from the truck to their final destination. Charging stations of the present invention provide the power, and autonomy necessary to enable this, a modular drone allows for different types of packages to be delivered by swapping modules to accommodate different use cases.

It will be understood that there are numerous modifications of the illustrated embodiments described above which will be readily apparent to one skilled in the art, such as many variations and modifications of the compression connector assembly and/or its components including combinations of features disclosed herein that are individually disclosed or claimed herein, explicitly including additional combinations of such features, or alternatively other types of contact array connectors. Also, there are many possible variations in the materials and configurations. These modifications and/or combinations fall within the art to which this invention relates and are intended to be within the scope of the claims, which follow. It is noted, as is conventional, the use of a singular element in a claim is intended to cover one or more of such an element.

We claim:

1. A remotely deployable modular drone system comprising:
a multi-rotor aircraft configured for vertical takeoff and landing;
one or more remotely locatable landing pods, each configured to pair with, and provide an electrical charge to, said multi-rotor aircraft;
wherein said multi-rotor aircraft and said landing pods form a network for relaying data to other multi-rotor aircraft and other landing pods;
wherein said multi-rotor aircraft is further configured to coordinate with one of said landing pods to land thereon substantially autonomously.

2. The system of claim 1 further comprising a computing system configured to receive user instruction data and transmit said data to said network.

3. The system of claim 1 wherein said landing pods further comprise an electromechanical interface to establish an electromechanical connection with said multi-rotor aircraft.

4. The system of claim 1 wherein said multi-rotor aircraft receive sensor data collected by said one or more landing pods to facilitate landing.

5. The system of claim 4 wherein said sensor sensor data is collected by a pressure sensor.

6. The system of claim 4 wherein said sensor sensor data is collected by an infrared proximity sensor

7. The system of claim 1 wherein said one or more landing pods further comprise an electromechanical interface configured to mate with said multi-rotor aircraft and a locking mechanism for securing said multi-rotor aircraft to said landing pod.

8. The system of claim 1 wherein said said communications system is further configured to communicate with a remote computing device.

9. The system of claim 1 wherein said landing pods are configured to operate as part of a ground-based sense-and-avoid system that monitors traffic within a local airspace.

10. A remotely locatable landing pod comprising:
a landing platform configured to receive and support a multi-rotor aircraft;
an electromechanical interface to establish a mechanical connection with said multi-rotor aircraft;
a power supply for providing an electrical charge to a multi-rotor aircraft;
one or more sensors for detecting the presence of a multi-rotor aircraft;
a communications subsystem comprising one or more transceivers for communicating with a multi-rotor aircraft and with other landing pods;
a landing subsystem for analyzing data received by said sensor and communicating with said multi-rotor aircraft to facilitate receipt of said multi-rotor aircraft by said landing platform.

11. The landing pod of claim 10 wherein said electromechanical interface further comprises a power conduit configured to mate with said multi-rotor aircraft and a locking mechanism for securing said multi-rotor aircraft.

12. The landing pod of claim 10 wherein said communications system is further configured to communicate with a remote computing device.

13. The landing pod of claim 10 wherein said communications subsystem is further configured to communicate with a remote computing device and receive instruction from a user on operation of the multi-rotor aircraft.

14. The landing pod of claim 10 wherein said sensor is a pressure sensor.

15. The landing pod of claim 10 wherein said sensor is an infrared proximity sensor

16. The landing pod of claim 10 wherein said communications subsystem is further configured to exchange data with other landing pods in a network.

17. A communications network comprising:
a plurality of nodes comprising landing pods, multi-rotor aircraft node, and computing devices;
wherein said landing pod nodes and said multi-rotor aircraft comprise a plurality of sensors that generate data concerning the location and status of said nodes;
wherein said nodes are configured to receive, transmit, and relay data from other nodes in the network;
and wherein said computing device is configured to provide instruction to at least one multi-rotor aircraft via said network.

18. The landing pod of claim 17 wherein said sensor is an infrared proximity sensor

19. The landing pod of claim 17 wherein said communications subsystem is further configured to exchange data with other landing pods in a network.
